(19) United States
(12) Patent Application Publication
(10) Pub. No.: US 2008/0228559 A1
(43) Pub. Date: Sep. 18, 2008

(54) SYSTEM AND METHOD FOR CREATING FINANCIAL INVESTMENT INDICES

(76) Inventors: Kei Kianpoor, Highland Lakes, NJ (US); John Eagleton, Brooklyn, NY (US); Lars Heimsath, Brooklyn, NY (US)

Correspondence Address: KEITH D. NOWAK, CARTER LEDYARD & MILBURN LLP, 2 WALL STREET, NEW YORK, NY, 10005, US

(21) Appl. No.: 12/049,710

(22) Filed: Mar. 17, 2008

Related U.S. Application Data
(60) Provisional application No. 60/918,188, filed on Mar. 15, 2007.

(51) Int. Cl. G06Q 90/00

(52) U.S. Cl. 705/10

(57) ABSTRACT

The present invention is a system that creates indices based on the “buy, sell and hold” research recommendations of research firms, tracks the performance of those indices, and allows clients to search for top performing indices according to a variety of search parameters and filters through a proprietary text navigation searching mechanism. Once the indices are created it can be offered to investors for a fee. The fee compensates the research firm and is defined by a fee structure that varies based on the method of compensation selected.

### FIELD OF THE INVENTION

The present invention relates to financial instruments. In particular, the present invention relates to the creation of indices of financial instruments and payment structures related thereto.

### BACKGROUND OF THE INVENTION

Financial investment indices are used to assist investors to make prudent investment decisions. However, the organization, filtering and tracking of one or more financial investment index has been problematic. Financial indexes have lacked quality due to the failure to incentivize elite research analysts to participate in an economically cost effective manner. Additionally, tracking and filtering of a financial investment index has been limited due to the lack of sophistication of the software tools employed. The subject invention satisfies the above-deficiencies.

### SUMMARY OF THE INVENTION

The present invention is a system that creates indices, tracks the performance of those indices, and allows clients to search for top performing indices according to a proprietary text navigation searching mechanism. Recommendations are used to build the indices that could include any security or asset class such as equities, fixed income, currencies or commodities. A “Navigation Sentence” drives the text navigation searching mechanism. The navigation sentence is the control panel that allows one to search and filter and create indices based on any number of criteria and parameters based on the input of different research providers. Once the indices are created it can be offered to investors for a fee. The fee compensates the research firm and is defined by a fee structure that varies based on the method of compensation selected.

### BRIEF DESCRIPTION OF THE DRAWINGS

FIG. 1 is a flowchart illustrating the process of index calculation of the present invention;

FIG. 2 is a screen shot illustrating a graphical user interface of the present invention displaying a navigation sentence and a ranking table;

FIG. 3 is the screen shot of FIG. 2, wherein the navigation sentence is altered by selecting a time period;

FIG. 4 is the screen shot of FIG. 2, wherein the navigation sentence is altered by selecting index algorithms;

FIG. 5 is the screen shot of FIG. 2, wherein the navigation sentence is altered by selecting a research style;

FIG. 6 is the screen shot of FIG. 2, wherein the navigation sentence is altered by selecting an option for funds;

FIG. 7 is the screen shot of FIG. 2, wherein the navigation sentence is altered by selecting an option for portfolios;

FIG. 8 is the screen shot of FIG. 2, wherein the navigation sentence is altered by selecting an option for sectors;

FIG. 9 shows an index ranking table for the navigation sentence shown in FIG. 8;

FIG. 10 shows a historical index performance chart for the top rated fund shown in the table of FIG. 9;

FIG. 11 is a flowchart illustrating indexes fee structure method of the present invention;

FIG. 12 is a flowchart illustrating the bid for performance method of the present invention;

FIG. 13 is a flowchart illustrating the pay for performance method of the present invention; and

FIG. 14 shows the flowchart of FIG. 1 with an additional feature illustrating a quality control loop process of the present invention.

### DETAILED DESCRIPTION OF THE PREFERRED EMBODIMENTS

The present invention creates indices based on “buy, sell and hold” research recommendations of research firms or research entities, tracks the performance of those indices, and allows clients/investors to search for top performing indices according to a variety of search parameters and filters through a proprietary text navigation searching mechanism. Research firms include but are not limited to financial analysts, industry experts, intelligence and security experts. Recommendations include but are not limited to recommendations to buy or sell a security, components of an existing index or components of a product, or components affiliated with a person, group, or team. Indexes are created for “financial instruments” defined by non-limiting examples such as stocks, bonds, mutual funds, exchange-traded funds (ETFs), exchange-traded notes (ETNs), options, calls, puts or any other structured product or derivative product.

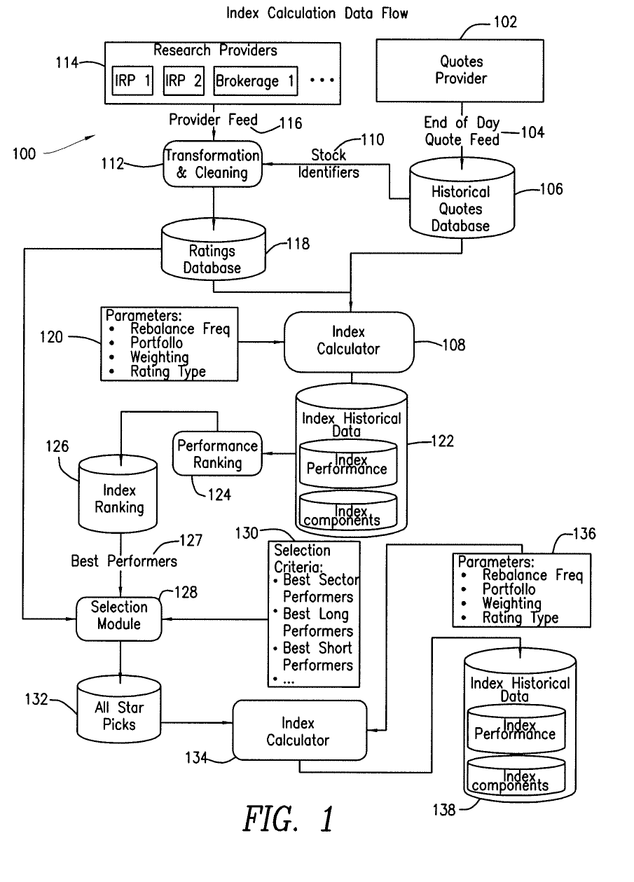

First, referring to FIG. 1, the software logic is described in a flow chart format as well as the hardware components associated therewith. At block 102 the quotes provide pricing information for equities, for example, stocks. This pricing information is both historical and current, and may be provided by, for example Financial Times Interrogative, Reuters or Thompson Financial. Block 104 denotes the fees of specifically current end of day quotes from block 102. Block 106 is a historical quotes database in which data of prior days' quotes are stored. Block 106 more specifically denotes an MSSQL Server 2005, as a non-limiting hardware example. The historical quotes database at block 106 provides stock identifiers 110. Block 114 denotes the research providers that provide equity rating information such as, for example, buy sell and hold recommendations. These research providers can be fundamental research providers such as, for example, JP Morgan or Goldman Sachs or quantitative research providers having quantitative models such as Columbine Capital or Channel Trend. The recommendations that are used to build the indices could include any security or asset class such as equities, fixed income, currencies or commodities.

The recommendation to buy or sell any of the securities in these different asset classes could be used to build indices or combinations of indices from different asset classes. So, for example, the index created could be based on a combination of equities in the resources sector in Argentina, recommendations on the Argentine currency, the peso, fixed income or bond recommendations on the Argentine sovereign debt, and include recommendations to buy or sell commodities relevant to the Argentine economy. This combination of securities in different asset classes allows the system to build indices that capture specific economies, markets, portfolios or sectors.

Referring still to FIG. 1, at block 116 the data feed from the research providers of block 114 is sent to transforming and cleaning module at block 112. Transforming and cleaning module 112 also receives the feed of stock identifiers 110 that, along with provider feed 116, is “normalized” since the data received is provided in different formats. For example, the stock “tickers” from stock identifiers 110 may be any one of CUSIP, ISIN, or SEDOL and thus require normalization. Regarding provider feed 116, the various rating scales thereof must be normalized. From transformation and cleaning module 112 the normalized data is fed at block 118 to the ratings database, a MSSQL server 2005, for example. At block 120 parameters of the indices are calculated. Examples of parameters are rebalance frequency, portfolio, weighting, and rating type, by non-limiting example. Portfolio narrows the coverage of a research provider to a specific portfolio which may be an existing market index or a streak portfolio in a certain sector or industry according to an industrial classifier such as Dow Jones or ICB. Weighting determines how much weight is given to any one component of the index. Examples include market capitalization weighting, price weighting and equal weighting. Rating type is the calculation of indices based on positive, neutral and negative research provider ratings.

The parameters 120 are fed into index calculator at block 108. Index calculator also receives transformed and cleaned data from ratings database 118 as well as data from historical quotes database 106. Index calculator employs the above data to calculate the current value of a specific index. At block 122 on SQL database receives data from index calculator 108 and portions this data as index historical data, index components data and index performance data. The index historical data is the prior performance history for a specific index. The index components data includes the stock index and the pricing information for that stock on a certain date. Index performance data is the historical value of an index as calculated by the sum of index component weight multiplied by the index component price, resulting in the value of the index on a certain date. From the database at block 122, performance ranking is obtained at block 124 based on the index performance data of database 122. The data is next fed from performance ranking 124 to index ranking at block 126 where indices are sorted based on performance by ascertaining which research provider employs a better index based on, for example, a certain portfolio or sector.

At block 127 the best performers from index ranking 126 are provided to selection module 128. Also provided to selection module 128 is data from ratings database 118 consisting of the best performers by ratings for each sector. Data selection variables are also inputted into selection module 128, which include, for example, best sector performers, best long performers and best short performers. All of the above data and variables fed into selection module 128 allows one to produce a combination of indices. For example, to create the best index in the technology sector, one would select this sector along with the best short performers and best long performers in the technology sector to formulate a new index. From selection module 128 the data is stored at block 132 in all star picks database. At block 136 the same parameters 120 applied at index calculator 108 (rebalance frequency, portfolio, weighting, rating type) form the basis for the calculations performed by index calculator at block 134 along with the data received from all star picks database 132. The resulting calculation of indices is stored at block 138 which is a database having equivalent functionality to that of SQL database 122.

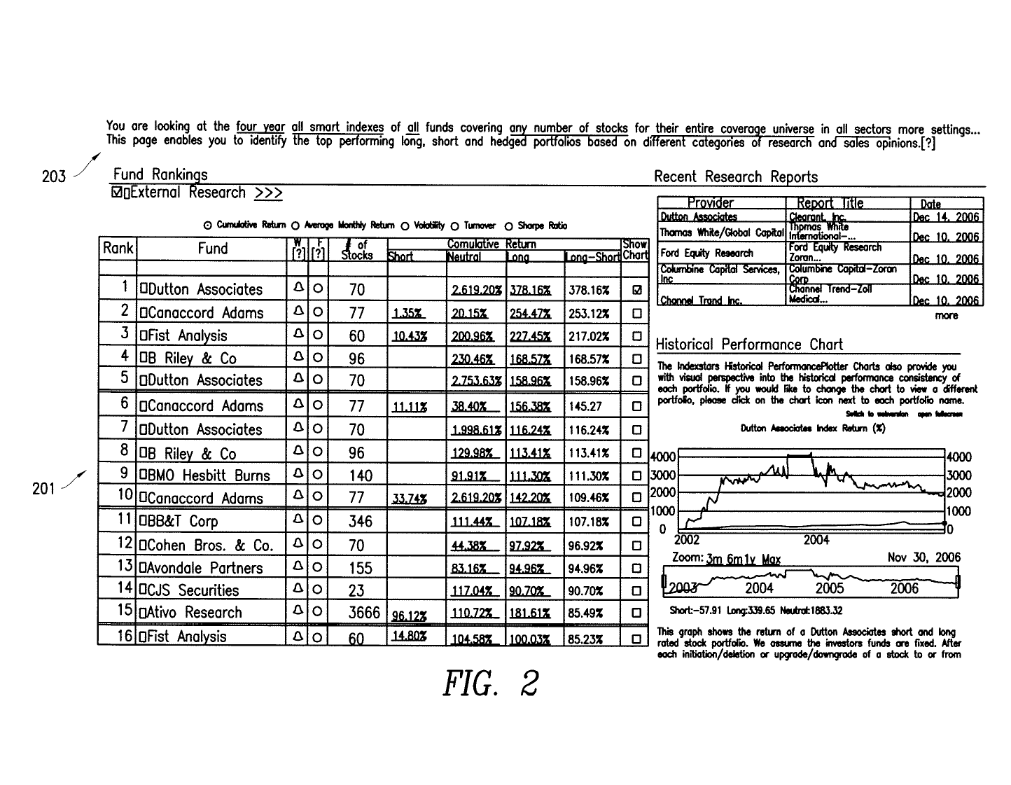

Next FIGS. 2-10 describe the graphical user interface of the subject invention. FIG. 2 shows an index ranking table 201 that will show top performing indices when modified by a client-driven navigation sentence 203. The navigation sentence drives everything in the system because it serves as the control panel that allows one to search and filter and create indices based on any number of criteria and parameters based on the input of different research providers. The navigation sentence 203 shown in FIG. 2, states “You are looking at the four year all smart indexes of all firms covering any number of stocks for their entire coverage universe in all sectors.”

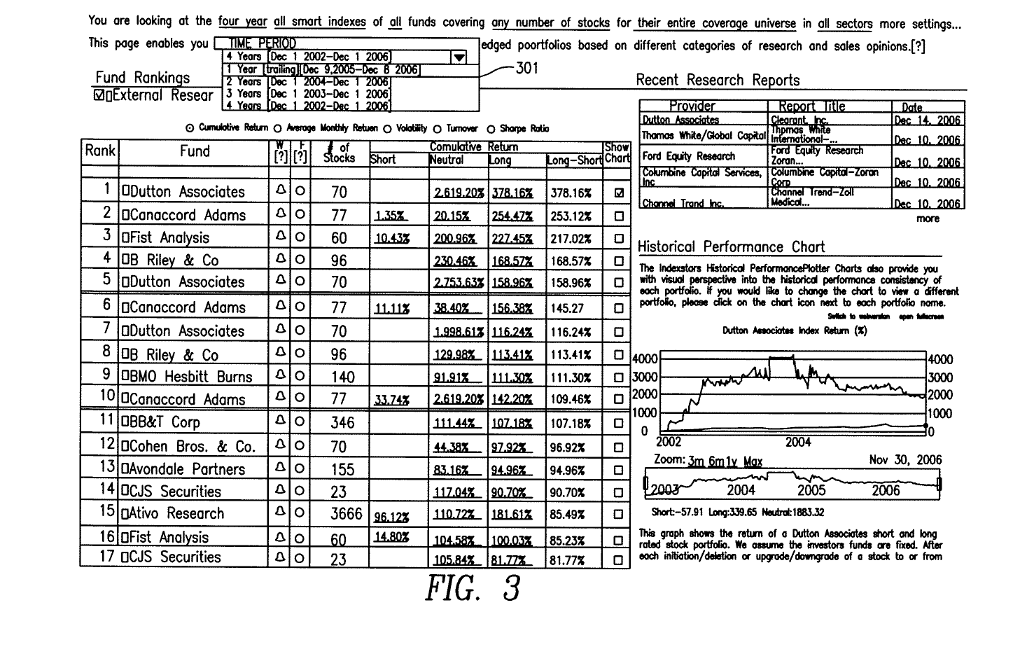

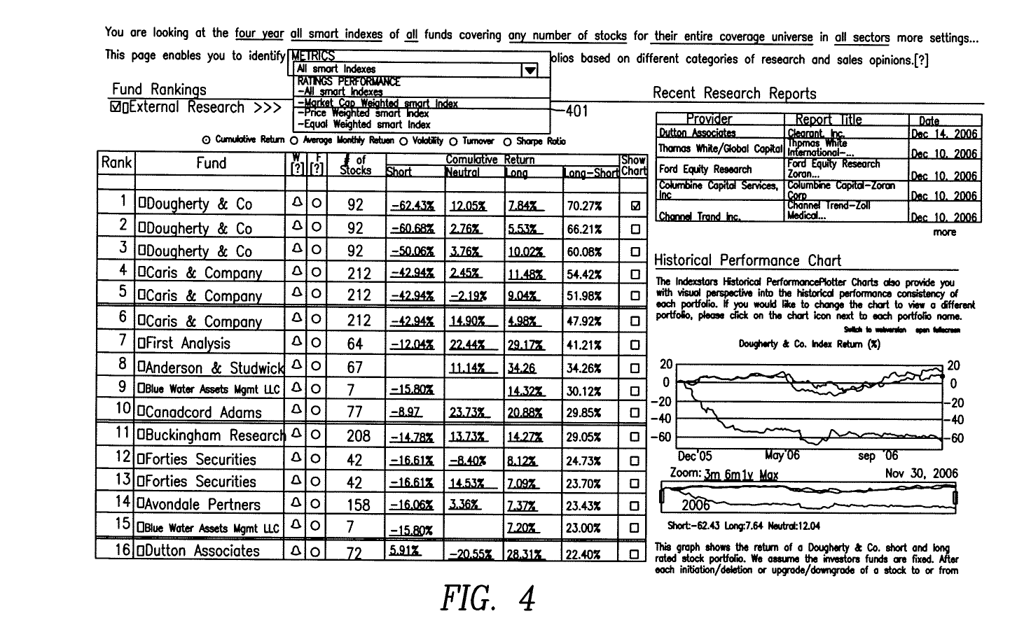

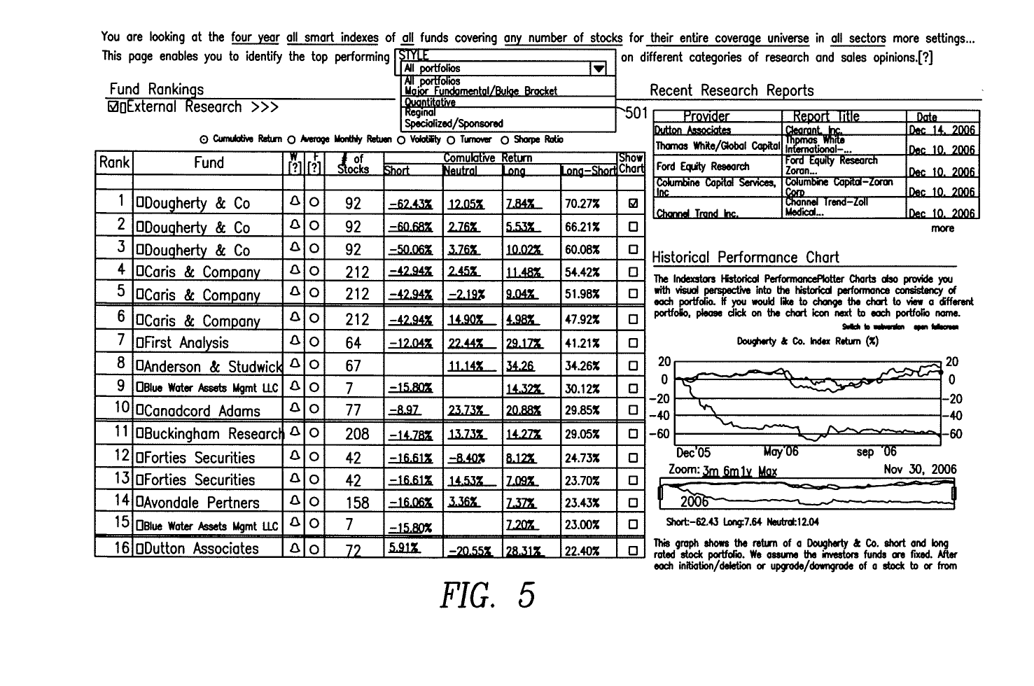

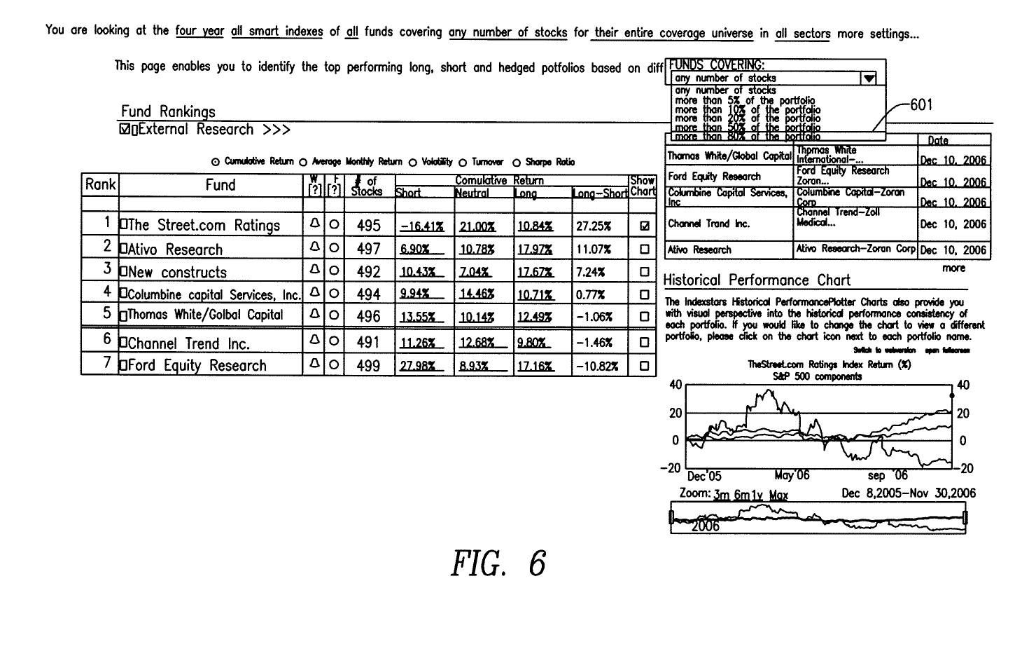

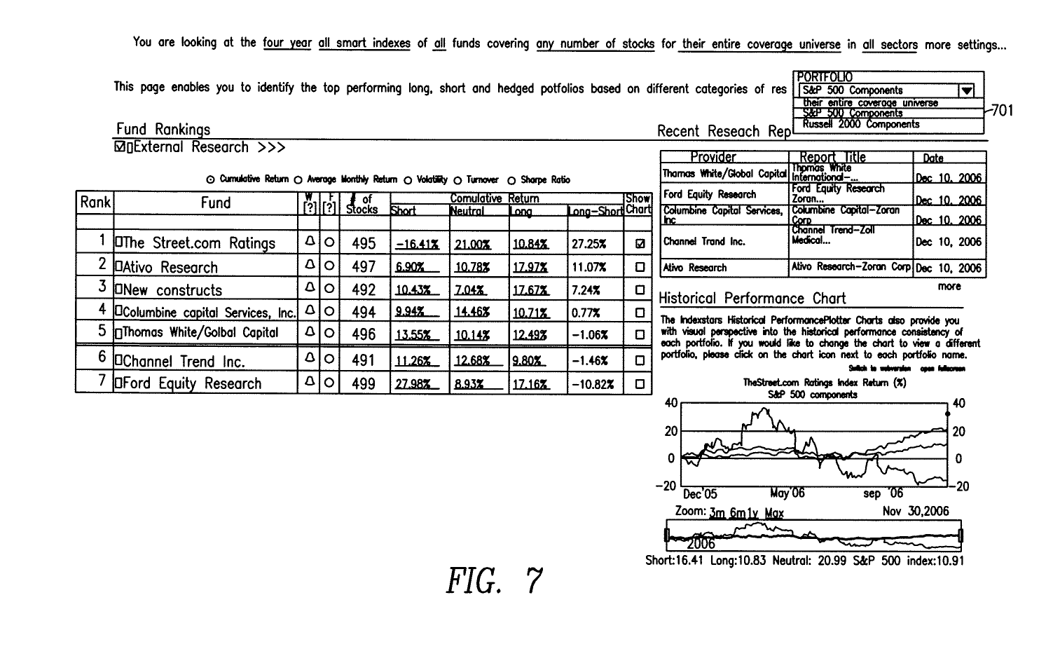

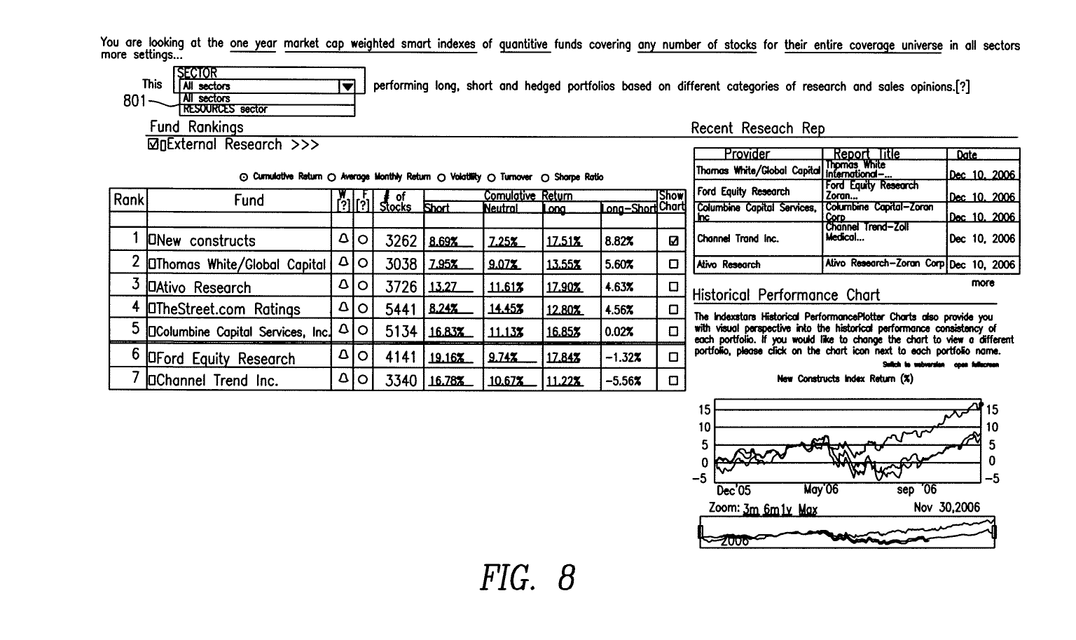

The navigation sentence can be changed by moving the mouse over the underlined words and selecting different options and filters from the dropdown boxes. This allows clients to select different ways of searching and creating indices according to a variety of options. These dropdown options include: different time periods 301 (FIG. 3), different algorithms and ways of calculating the indices 401 (FIG. 4), different types of research firms depending on their research style (fundamental, quantitative, specialized, etc) 501 (FIG. 5), different funds covered 601 (FIG. 6) different portfolios of stocks such as the S&P 500, Russell 2000, large cap, mid cap, value and growth 701 (FIG. 7), different sectors 801 (FIG. 8), different countries and regions and with different rebalancing options.

As shown in FIG. 3, in the navigation sentence one can start by moving the mouse over the time period “four years” and a dropdown box that gives the option to select different time periods such as 1, 2, 3 or 4 years or some other pre-defined time period. For example, 1 year is selected at 301.

As shown in FIG. 4, in the second dropdown one has the option different index calculation algorithms. In this dropdown one can select all indices, market cap weighted, equal weighted or price weighted indices. Market cap weighted indices is selected from the dropdown at 401.

As shown in FIG. 5, in the third dropdown one has the option of including research firms with different research styles such as fundamental, bulge bracket, quantitative, regional, specialized or sponsored. Each of these research firms have different research methodologies and each firm or type of firm will generate a different recommendation on each stock or component in the creation of indices. Quantitative research is selected from the third dropdown at 501.

As shown in FIG. 6, in the fourth dropdown, “any number of stocks” one can filter out research firms that cover a certain percentage of a portfolio or index. So, for example, if one is looking at a portfolio consisting of S&P 500 components one could through this dropdown select to include only firms that cover more than 80% of the components of the S&P 500. For this example, firms that cover at least 80% of the components in the S&P 500 index are selected at 601.

As shown in FIG. 7, in the fifth dropdown, “for S&P 500 components” one has the option of including research firms that cover components of a specific index or stocks in a specific portfolio. The portfolio could be a portfolio of most actively traded stocks or a portfolio of small cap stocks. For this example, a portfolio of S&P 500 components is selected at 701.

As shown in FIG. 8, in the sixth dropdown, “in all sectors” we have the option of including research firms covering stocks in specific sectors such as resources or healthcare. For this example, resources stocks is selected at 801. Since S&P 500 components was previously selected in the fifth dropdown, the selection in this dropdown will filter the portfolio to resources stocks in the S&P 500.

There are additional filters and search criteria in the “more settings” link at the end of the navigation sentence which allows one to look at other options such as the rebalancing frequency or to filter for different regions and countries.

Each time one selects a different option from the dropdown boxes in the navigation sentence the page reloads and the ranking table updates based on the new options, filters and parameters.

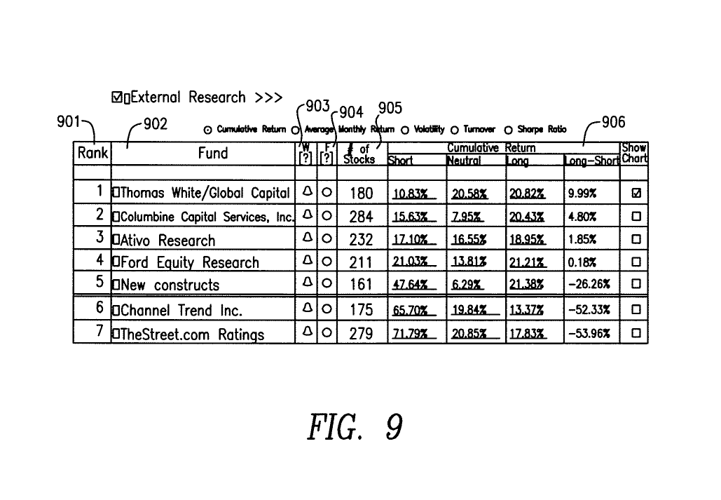

Based on the selected navigation sentence: “You are looking at the one year market cap weighted smart indexes of quantitative firms covering 80% of the S&P 500 in the resources sector” FIG. 9 shows the index rankings and the performance results. The Index ranking table of FIG. 9 shows in the columns from left to right: the rank 901, the name of the index provider 902 (which in this case are the individual research firms or combination of research from several research firms) the weighting applied to the index 903, the rebalancing frequency 904, the number of stocks in each index 905 and the returns 906. The returns are divided into 4 columns: the return of the “short, neutral, long” recommendations as well as the performance of the long minus short (long-short) indices for a given research providers/index. Just above the table one has the option of looking at cumulative returns, average monthly returns, volatility of the indices, turnover rates for each index and sharpe ratios. Each data point in the table can be clicked on to get a detailed view of all the components of the index and the performance for each component. The last column on the table allows one to see the historical performance chart for each index.

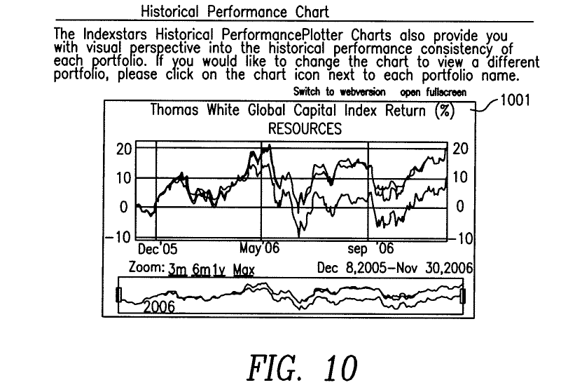

In the table of FIG. 10, Thomas White/Global Capital 1001 is ranked #1 based on the criteria selected in the navigation sentence and the performance for the Thomas White/Global Capital index over the past one year based on a market cap weighted algorithm for resources stocks in the S&P 500. The table shows the performance of this index based on the short, neutral and long recommendations and well as the performance of the long minus the short indices for Thomas White/Global Capital.

The navigation sentence of the present invention permits the creation of an unlimited number of indices for different portfolios, sectors and regions based on different weighted and un-weighted algorithms, then rank these different indices and identify the best performing indices as shown in the table of FIG. 9.

After using the selection process of the present invention to identify best performing indices for different sectors or portfolios based on long or short recommendations, then “smart combo” indices can be built based on the combinations of different research providers. For example, Thomas White/Global Capital may have the best performing “short” index for resources components in the Russell 2000 and Columbine Capital Services may have the best performing “long” index for resources components in the Russell 2000. Thomas White/Global Capital's “short” portfolio can then be combined with Columbine's “long” portfolio and create a new “smart combo” index based on the short and long recommendations made by the two firms.

At the top of the table of FIG. 9 there is an option to include “Firms” or “Individuals.” “Firms” includes the research recommendations made for example by all the individuals within a firm or in the case of some firms the recommendations are generated by a quantitative model built and designed by the firm. In the case where the recommendations of the “Firm” are based on individual people, those individuals within a firm could include research analysts, salespeople who make recommendations to buy or sell a security. A “Firm” could be divided into “teams” or groups of individuals. The recommendations from a group of individuals could be used to create an index.

The above description illustrates how the navigation sentence of the present invention steers the creation of indices based on selected criteria and the input of the research providers. Accordingly, indices may be created looking at a specific style of research (quantitative) in a specific asset class (equities), in a specific sector (resources), in a specific portfolio (S&P 500 components), according to a specific index algorithm. The navigation sentence can also be altered to generate a list of research providers that have the best performance for that criteria. Then run a second search can be conducted looking at a specific style of research (fundamental) in a specific asset class (fixed income) for a specific algorithm and generate a list of research providers that have the best performance for that criteria. Once the top performing research providers for those two criteria have been determined by the system any number of top performing research providers can be combined to create an index based on the combination of their research recommendations.

Fee Structure

Once the index is created using the index calculation process described above, fees can be calculated using a fee structure process. The fee structure method of the present invention include an ETF/ETN Fee Structure, a Bid for Performance method, and a “Pay for Performance” method. The fee structure described here is in no way be limited to the below description as it can apply with any ETF/ETN and could also apply to closed-end or open-end ETF/ETNs.

Module 1: ETF/ETN Fee Structure

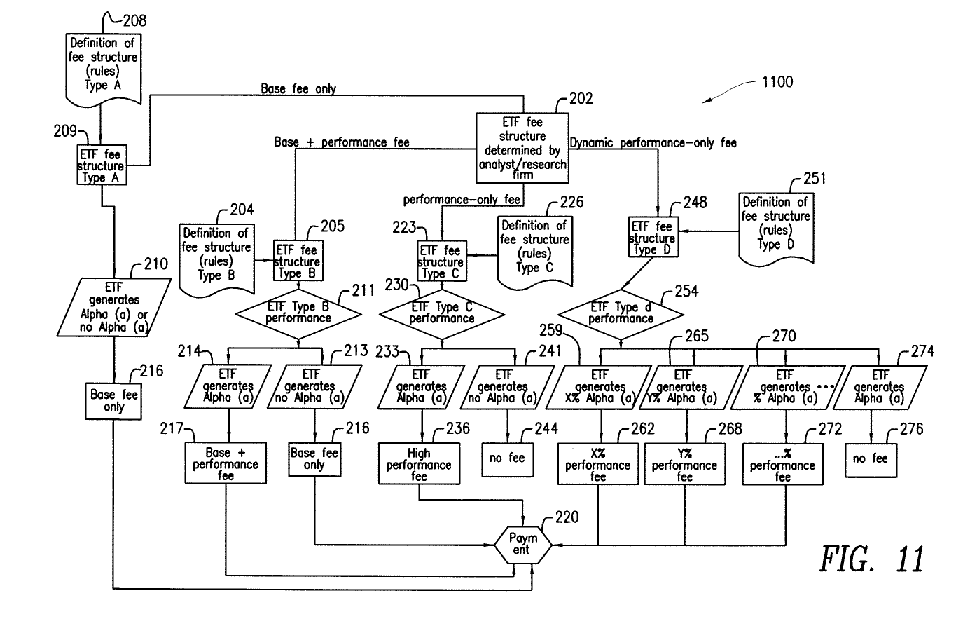

FIG. 11 shows flowchart 1100 describing the Indexes Fee Structure of the present invention. Fees are determined based on the fee structure selected by the analyst/research firm (also called research firm/index provider) 202. The fee structure allows the ETF to have different fees based on different criteria. The types of fee structure include base fee only shown by block 209, base and performance fee shown at block 205, performance fee only shown by block 223, and dynamic performance-only fee shown at block 248. By selecting one of the above options, the research firm/index provider sets the minimum performance amount it desires to receive by licensing its underlying index components for the creation of an ETF.

Fee Structure A: X% Base Fee Only.

If the firm 202 selects a base fee only method of payment the process starts via block 209. Block 208 defines the rules for the present fee structure. The base fee only rules are described by the following example. For instance, the firm 202 sets a fixed base fee, which it will receive from the index licensee. The research provider sets the base fee (i.e. 4%). The fees will be disclosed according to all rules, regulations and best practices so that investors are fully aware of the fees being charged by the research firm 202.

After selecting the base fee method 209, the process moves to block 210 where it is determined whether the index/ETF generates alpha or not. Regardless of whether or not an alpha is generated, a base fee is still paid according to block 216 and payment is made to the analyst/research firm in block 220.

Fee Structure B: X% Base Commission+Y% Performance-based Fee.

If the analyst/research firm 200 selects the base and performance fee then the fee would be determined via the process following block 205. Block 204 defines the rules for the present fee structure. Based on these rules, the research firm 202 can set a fixed base fee (X%), which it will receive from the index licensee. The research provider sets the base fee (i.e. 4%). In addition, the research firm 202 can set a performance-based fee (Y%) that the firm receives if the exchange-traded fund generates a positive return. The research firm and/or index provider sets the performance-based fee. For example, the research firm could set a 5% performance fee. If the index generates a negative return then the performance-based fee would be zero. However, if the index generates a positive return, the research provider will receive 5% of the return on the ETF/ETN in fees (“the performance-based fee”).

After Block 205, the process moves to Block 211 that determines the performance for the present payment method-Type B fee structure. If there is positive performance and alpha is generated (block 214) then the analyst/research firm 202 will receive a performance based fee and base fee (block 217). If negative performance and alpha is not generated (block 213) then the analyst/research firm 202 will not receive a performance based fee and will only receive a base fee (block 216). Payment is made in block 220.

Fee Structure C: No Base Fee+Z% Performance-based Fee.

If the analyst/research firm 202 selects the Performance fee only type of payment, then this fee structure would be determined via the process following block 223. Block 226 describes the rules for the present fee structure. Here the rules are defined by the following: the research firm 202 has the option to opt for no base fee and instead charge a performance-based fee (Z%). In this case, the research firm 202 would not receive a base fee. The research firm 202 would only receive a fee if the index generates a positive return. For example, the performance-based fee could be 7% and if the ETF/ETN generates a negative return, the research provider will neither receive a base commission nor receive a performance related commission, but if the ETF/ETN generates a positive return, then the research firm would receive a fee equal to 7% of the positive returns generated by the ETF/ETN.

From Block 226, the process moves to Block 230. Block 230 determines the performance for the Type C fee structure. If there is positive performance and alpha is generated (block 233) then the analyst/research firm 202 will receive a performance based fee (block 236) and payment is made in block 220. If negative performance and no alpha is generated (block 241) then the analyst/research firm will not receive any fees (block 244).

Fee Structure D: No Base Fee+XY% Dynamic Performance-based Fee.

If the analyst/research firm 202 selects Dynamic performance fee only then the fee would be determined via the process following block 248. Block 251 describes the rules for the fee structure shown at block 248. The rules for Fee structure D lets the research firm opt for a no base fee and set a dynamic performance-based fee. The dynamic performance-based fee allows the research firm and/or index provider to define multiple levels of positive returns and charge a different fee for each performance level.

For example:

| Index Return (in %) | Performance based Fee (in %) |
|---|---|
| <0 | No performance fee |
| 0-5 | 5 |
| 5.01-10 | 7 |
| 10.01-20 | 10 |
| 20.01-30 | 13 |
| Etc. | Etc. |

From Block 248 the process moves to block 254. Block 254 determines the performance for Type D. In this instance, if there is positive performance and X% of alpha is generated (block 259) then the analyst/research firm 202 will receive a performance based fee of X% (block 262). If there is positive performance and Y% of alpha is generated (block 265) then the analyst/research firm will receive a performance based fee of Y% (block 268). If there is positive performance and Z% of alpha is generated (block 270) then the analyst/research firm will receive a performance based fee of Z% (block 272). For any of those scenarios where fees are generated, payment is made in block 220. If negative performance and no alpha is generated (block 274) then the analyst/research firm will not receive any fees (block 276).

Module 2: Bid for Performance Process via Dutch Auction System

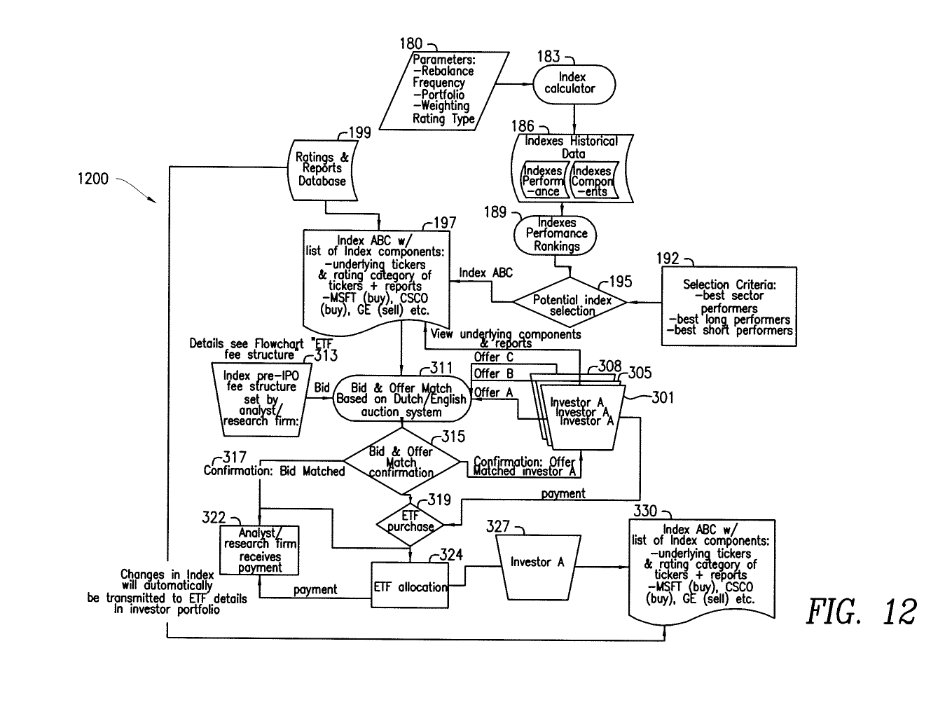

Referring now to FIG. 12, flowchart 1200 shows a Bid for Performance payment method of the present invention. The parameters block 180 is equivalent to the parameter block 120 of FIG. 1. Likewise, the index calculator 183 is equivalent to the index calculator block 108 of FIG. 1. Block 186 stores the historical data for the index so that the indexes can be ranked according to performance in block 189. Based on the performance ranking the indexes will be selected in block 195. The selection criteria such as best sector or best long or short performance is determined in block 192. Based on the selection criteria block 192 and potential index selection in block 195 an index is selected in block 197. Ratings and reports block 199 describe the reason for which the component may be in an index at block 197.

The next step of the process involves an auction to determine the fees that will be paid based on a level of performance reached by the analyst/research firm. The auction could be done for example as a dutch, English or other style auction. The auction would consist of a bid by the analyst/research firm in block 313 and offers from an unlimited number of investors represented in blocks 301, 305, 308. Block 313 is called an index pre-IPO fee structure set by analyst/research firm and is equivalent to the block 202 in FIG. 11.

The auction takes place in block 311. The matching bid and offers as a result of the auction are confirmed in block 315. Confirmation of matching bids and offers would be sent out via line 317. Based on the matching bid offers in block 315 the index/ETF/basket of stocks would be purchased in block 319 based on payment of money from investors in blocks 301, 305, 308. The ETF/basket/portfolio of stocks would be created in block 324 for the Investor in block 327 and the investor would be able to see the underlying stocks related to that portfolio in block 330. The analyst/research firm receive fees and payments in block 322. Ratings and reports 199 block described above, here automatically transmit changes in index to ETF details in investor portfolio at 330.

The “Bid for Performance” process of the present invention is based on the Fee Structure process described above and acts as an add-on module that allows institutional as well as individual investors to bid on an ETF/ETN. The “Bid for Performance” process can be used with the process described above but can equally apply to any ETF/ETN as well as to closed-end or open-end ETF/ETNs.

The fee structure options for the Bid for Performance method is described above in the fee structure process and includes, but is not limited to, the following options:

Fee structure A: X% base fee only

Fee structure B: X% base commission+Y% performance-based fee

Fee structure C: No base fee+Z% performance-based fee

Fee structure D: No base fee+XY% dynamic performance-based fee

The Bid for Performance process can be described using the following example. Index provider “Firm A” selects Fee structure C as the payment type for its underlying index components. Index provider A defines Fee structure C as “No base fee plus 10% performance related fee.” The participants in the auction for this index can see a description of “Fee structure C” as well as the exact details of the underlying index components. The components information will consist of the actual tickers and ratings for each ticker.

In addition, the bidders have the ability to access the historically calculated performance of the index and, if using the index creation method of the present invention, the bidder would also have access to the most recent research reports from the research/index provider for each component of the index. The bidder could access the research report by clicking on the stock or rating for the index component and be re-directed to a Research Distribution System (RDS) of the subject invention. The RDS is linked to the ratings and reports database 199 and is updated every time there is a change in the underlying ratings or components.

Still discussing the example, for the bidding process on an ETF/ETN, the Fee structure C is defined as no base fee plus a performance-based fee. The participants of the auction are not able to see the minimum percentage number the research/index provider expects to receive for this index. In the next step of the auction process, participants can now place an actual offer for this index, by specifying the performance-based fee in percentage terms that they would be willing to pay if the index generates a positive return for the time period specified. The bidders can also specify the amount of units for which they are interested in bidding. In this example there are 5 participants (A to E) in the auction having the following offers for the selected index:
Participant A: 30 units for a 9% performance related commission
Participant B: 30 units for a 11% performance related commission
Participant C: 20 units for a 12% performance related commission
Participant D: 40 units for a 14% performance related commission
Participant E: 10 units for a 16% performance related commission
   In this scenario, the bid-to-cover ratio is 1.3, so not every bidder will receive units of the index. The bids will be filled from the highest until the entire 100 units have been sold (assuming it is a closed-end fund with 100 units). This auction will be sold at a performance-based fee of 11% and all bidders will pay the same amount (11%).

Once it has been determined which bidders will receive their specified units, the index will be allocated accordingly to the investors. The research firm will also receive a confirmation of the detailed bids to be able to potentially select a different or adjusted fee structure for another index that they would like to provide an index. This feedback loop will allow the research/index provider to determine the highest value for its underlying rating components.

Each investor will receive the amount of units they are confirmed for and a detailed report with each component and current rating. Potential rating or component changes in the index will be automatically transmitted to the purchaser of the index units.

Module 3: “Pay for Performance” ETF/ETN

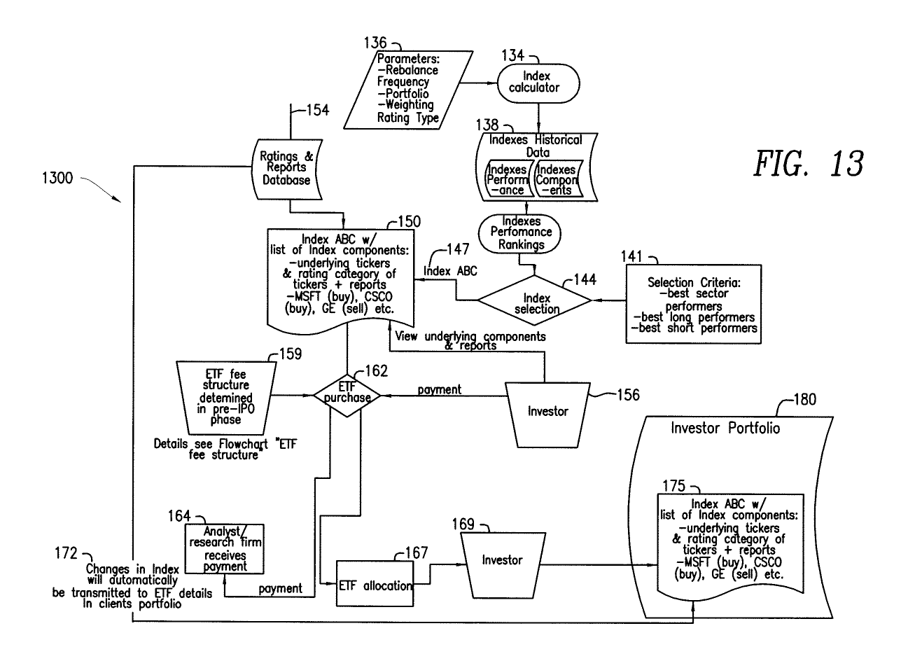

The Pay for Performance Flowchart 1300 is shown in FIG. 13. Parameters block 136 is equivalent to parameters block 120 in FIG. 1. Likewise, index calculator 134 is equivalent to the index calculator 108 in FIG. 1. Block 138 stores the historical data for the index so that the indexes can be ranked according to performance. Based on the performance ranking the indexes will be selected in block 144. The selection criteria such as best sector or best long or short performance is determined in block 141. Based on the selection criteria block 141 and index selection in block 144 an index is selected in line 147 and the details of the index are stored in block 150. Ratings and reports which describe the reason for which the component may be in an index are stored in block 154.

The next step of the process involves the payment for the performance of the ETF/portfolio of stocks. Based on the index components in block 150, the ETF portfolio will be purchased in block 162 by an investor in block 156. Based on the fee structure of block 159 (equivalent to block 202 in FIG. 11) a payment is made to the analyst/research firm in block 164. In block 167 the ETF is allocated and owned by the investor in block 169 and added to the investor's portfolio in block 180. Ratings and reports 154 also automatically transmit changes in index to ETF details in investor portfolio at 175.

The “Pay for Performance” ETF/ETN process of the present invention is based on the ETF/ETN Fee Structure method described above in Module 1. Once the ETF/ETN Fee Structure has been selected, then the ETF/ETN units are auctioned via the “Bid for Performance” to the interested investors. It should be noted that the “Pay for Performance” method can be used and applied to any ETF/ETN and could also apply to closed-end or open-end ETF/ETNs. The “Pay for Performance” method of the present invention enables investors to buy ETF/ETN creation units once the ETF/ETNs have been launched and traded on an exchange.

Users can see a description of the fee structure as well as the exact details of the underlying ETF/ETN components via the Portfolio Composition File. The information displayed consists of the actual tickers and rating category for each ticker (i.e. buy, hold & sell) and their representative percentages.

In addition, the bidders have the ability to access the most recent research reports on each component from the research provider. The bidder can do so by clicking on the stock or rating for the index component and will be re-directed to a Research Distribution System (RDS) of the subject invention. The RDS is linked to the ratings and reports database 154 and is updated every time there is a change in the underlying ratings or components of the ETF/ETN.

Based on the fee structure that was defined by the research firm providing the underlying ratings, as well as the actual sponsor of the ETF/ETN, investors can purchase actual creation units of the ETF/ETN and allocate them into their portfolio.

The list of fee structure options for ETF/ETNs launched through an ISIP platform of the present invention, includes, but is not limited to, the following selections:
A. Fee structure A: X% base fee only
B. Fee structure B: X% base commission+Y% performance-based fee
C. Fee structure C: No base fee+Z% performance-based fee
D. Fee structure D: No base fee+XY% dynamic performance-based fee

The ISIP platform will carry a broad selection of different ETF/ETNs with different fee structures as described in the “Index Fee Structure” and “Bid for Performance” methods described above.

The following example describes the Pay for Performance method. Here, assume that an investor is interested in purchasing ETF/ETN allocation units for an ETF/ETN named “ETF/ETN ABC Technology.” The fee structure for this ETF/ETN was determined by the research provider and index sponsor as the Fee structure C defined as: “No base fee plus [Z]% performance-based fee.” The example also assumes that the fee structure of the ETF/ETN as being “No base commission plus a 8% performance-based fee.” For an investor to be able to purchase any number of units for the “ETF/ETN ABC Technology”, the investor must agree to pay no base commission upfront, but a performance related commission of 8% if “ETF/ETN ABC Technology” generates a positive return for the time period specified (i.e. 1 year).

If the ETF/ETN achieves the determined performance benchmark the research firm and index sponsor will receive the 8% performance related commission as compensation for providing the index and as well as sponsoring the derived ETF/ETN. Since investors can buy and sell ETF/ETNs like a stock at any time of the day, each holder of the ETF/ETN might have a different performance of units in the ETF/ETN, depending on when the ETF/ETN were purchased and sold. The exact performance of the ETF/ETN can be determined by calculating the return of the index based on the price and date when the investor buys the ETF/ETN as the entry point and then sells the ETF/ETN as the exit points, with its appropriate prices.

If the annual performance of an ETF/ETN is 20% (value on Jan. 1, 2006: $100/value on Dec. 30, 06: $120). Investor A bought the ETF/ETN at $104 and sold it at $118, which would result in a performance for the holding period of 13.46%. In this example, the investor would have to pay a commission of 8% of the 13.46% return.

Module 4. ETF/ETN Diversification Based on Research Provider's Methodology.

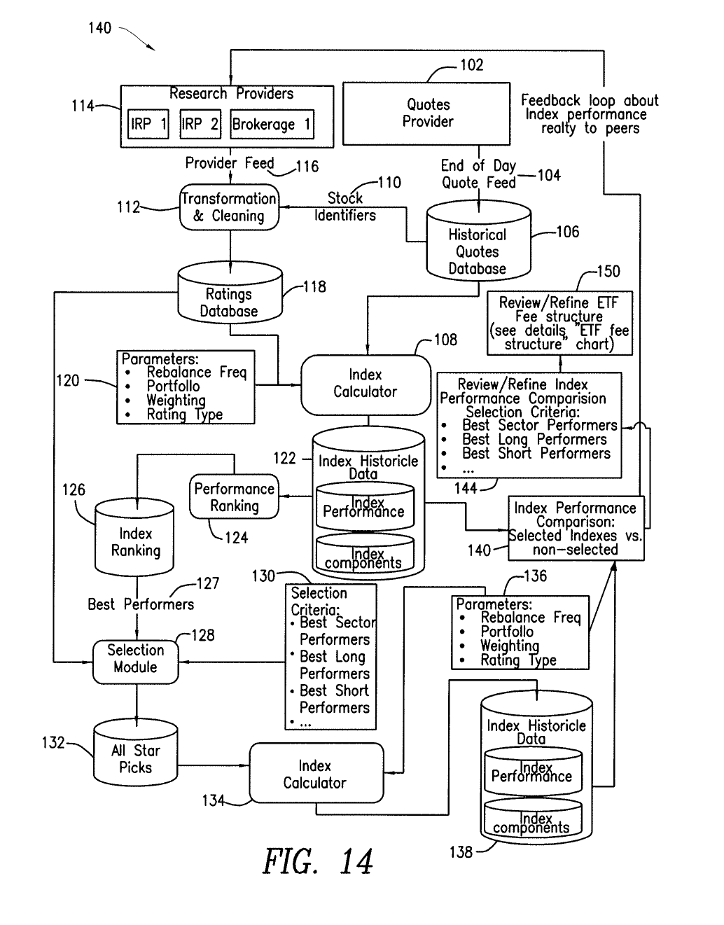

An ETF selection quality control loop flowchart 1400 is shown via FIG. 14. The ETF selection quality control loop is an additional feature to FIG. 1 that can be used to review and refine the process of index calculation described in FIG. 1. Here, the investor can continuously select modified/new index components based on a performance comparison (block 140) and selection criteria shown in block 144. The ETF Fee structure can also be reviewed and refined in block 150. The rest of the process is the same as described in FIG. 1.

The “Portfolio Diversification via research provider's methodology” is an integrated component of the ETF/ETN creation process and is selected via the “Navigation Sentence” option named STYLE. The database includes research firms with different research styles such as fundamental, bulge bracket, quantitative, regional, specialized or sponsored. In addition each separate style category can have different underlying models that drive the firm's evaluation process. The list of underlying models can include, but is not limited to growth, value, channel-checking, technical or momentum-driven research as well as combinations of the different types. This results in the fact that each research provider might potentially generate a different recommendation on each stock or component in the creation of indices and establish a high level of potential diversification.

Based on the selection of the research providers for the underlying index components, the combination of different research providers from different categories (i.e. quantitative, fundamental, bulge bracket) plus the different research styles applied by each research provider allow for a high diversification of stocks in the ETF/ETN.

While the invention has been described by way of example and in terms of specific embodiments it is not so limited and is intended to cover various modifications as would be apparent to those skilled in this art. Therefore, the scope of the appended claims should be accorded the broadest interpretation so as to encompass all such modifications.

1. A method for identifying financial index performance comprising:
selecting a plurality of research entities;
obtaining financial indexes from each of the research entities;
selecting a specific financial sector;
selecting a specific performance time period;
applying the specific financial sector and the specific performance time period to the financial indexes; and
listing the financial indexes hierarchically based on performance within the specific financial sector and the specific performance time period.

2. The method of claim 1, wherein the research entities are financial analysts.

3. The method of claim 1, wherein the research entities are industry experts.

4. The method of claim 1, wherein the indexes are created for financial instruments.

5. The method of claim 4, wherein financial instruments include exchange-traded funds.

6. The method of claim 4, wherein financial instruments include exchange-traded notes.

7. The method of claim 4, wherein financial instruments include stocks.

8. The method of claim 1, further comprising compensating the research entity.

9. The method of claim 8, wherein the research entity is compensated using a fee structure.

10. The method of claim 8, wherein the research entity is compensated based on performance.

11. The method of claim 8, wherein compensation is bid through an auction.

12. A method for identifying financial indices comprising:
providing control panel, said control panel having at least one variable criteria for an algorithm;
obtaining input from a research entity; and
combining said input and said variable criteria to create indices.

13. The method of claim 12, wherein the control panel is a navigation sentence.

14. The method of claim 12, further comprising a variable criteria for a type of fund.

15. The method of claim 12, further comprising a variable criteria for a style of research.

16. The method of claim 12, wherein the indices are ranked for performance.

17. The method of claim 12, further comprising a method of compensating the input entity using a fee structure.

18. The method of claim 12, further comprising a method of compensating the input entity using an auction.

19. The method of claim 12, further comprising a method of compensating the input entity based on performance.

20. The method of claim 12, further comprising refining said indices based on continuously selecting modified index components based on a performance comparison.
